(19) United States
(12) Patent Application Publication
(10) Pub. No.: US 2020/0282991 A1
(43) Pub. Date: Sep. 10, 2020

(54) ADAPTIVE CRUISE CONTROL SYSTEM FOR A MOTOR VEHICLE

(71) Applicant: Ford Global Technologies, LLC, Dearborn, MI (US)

(72) Inventors: Benjamin Maus, Düsseldorf (DE); Andreas Meyer, Kuerten (DE); Guido Weitkus, Koeln (DE); Goetz-Philipp Wegner, Dortmund (DE); Armin Mueller-Lerwe, Kerpen-Bergerhausen (DE); Samantha Medenbach, Pensacola, FL (US)

(73) Assignee: Ford Global Technologies, LLC, Dearborn, MI (US)

(21) Appl. No.: 16/808,641

(22) Filed: Mar. 4, 2020

(30) Foreign Application Priority Data
Mar. 5, 2019 (DE) 102019202981.7

(51) Int. Cl. B60W 30/17

(52) U.S. Cl. CPC B60W 30/17; B60W 2540/229; B60W 2554/00; B60W 2552/00

(57) ABSTRACT

A method for operating a motor vehicle having an adaptive cruise control system with a stop-and-go function, having the steps of:
bringing the motor vehicle to a stop upon detecting that a vehicle in front has stopped,
providing a start signal within a predetermined first time period upon starting of the vehicle in front,
reading safety-relevant data after the first time period has ended and if the vehicle in front is still stopped, and
suppressing a start signal if the safety-relevant data indicate a hazardous traffic situation.

### CROSS-REFERENCE TO RELATED APPLICATIONS

This patent application claims priority to German Application No. 102019202981.7 filed Mar. 5, 2019, which is hereby incorporated herein by its reference in its entirety.

### BACKGROUND

The disclosure relates to a method for operating a motor vehicle having an adaptive cruise control system with a stop-and-go function.

An adaptive cruise control system is a speed control system in motor vehicles that incorporates the distance from a vehicle in front or a vehicle ahead as an additional feedback and setting variable during control.

The expression adaptive cruise control (ACC) has become established in the international automotive industry.

Such an adaptive cruise control system is often part of a radar-assisted emergency braking assistant and is provided with a stop-and-go function in some motor vehicles.

With the stop-and-go function, automatic starting after a brief stop or restarting triggered by the driver are possible (after driver confirmation by touching the accelerator pedal or actuating an operating lever), up to the speed predefined by the driver. This function serves to improve comfort for the driver in cities and in congestion on motorways.

There may be a provision for the adaptive cruise control system to bring about starting of the motor vehicle within a predetermined time period, of for example three seconds, when the vehicle in front likewise starts to move again. The value of the predetermined time period in this case can be three seconds.

It has however proven in practice that a time period of 3 seconds may be too short, and it may take longer than three seconds until the vehicle in front restarts. In this case, however, the adaptive cruise control system does not bring about automatic starting, but rather the driver has to manually bring about starting, for example by touching the accelerator pedal or actuating the operating lever. The desired increase in comfort may not thus not achieved.

There is thus a need to specify ways in which an improvement is able to be achieved here.

### SUMMARY

The object of the disclosure is achieved by a method for operating a motor vehicle having an adaptive cruise control system with a stop-and-go function, having the steps of:
bringing the motor vehicle to a stop upon detecting that a vehicle in front has stopped,
providing a start signal within a predetermined first time period upon starting of the vehicle in front,
reading safety-relevant data after the first time period has ended and if the vehicle in front is still stopped, and
suppressing a start signal if the safety-relevant data indicate a hazardous traffic situation.

A two-stage procedure is thus provided. Only after a first predetermined time period of for example three seconds has ended is there a change to a second operating mode in which safety-relevant data indicating a hazardous traffic situation are recorded and evaluated. Use is thus made of the fact that hazardous traffic situations become apparent only after the first time period has ended. By virtue of the two-stage procedure of time-delayed recording and evaluation of safety-relevant data indicating a hazardous traffic situation, the expenditure for recording and evaluating data is reduced, and fewer computing resources are thus used.

According to one embodiment, the safety-relevant data indicate a motorway or approach road. In order to determine the location, i.e. whether the motor vehicle is situated on a motorway or approach road, location data from a navigation system of the motor vehicle may for example be evaluated. It is thus possible to take into consideration whether or not there is a high likelihood of crossing traffic resulting from non-motorized traffic participants, such as for example on motorways or approach roads.

According to a further embodiment, the safety-relevant data indicate an absence of a tight curve. It is thus possible to take into consideration that parts of the route are difficult to see and are therefore able to be monitored only to a limited extent by surroundings sensors of the motor vehicle. Hazardous traffic situations in unclear road conditions are therefore able to be avoided by suppressing automatic starting.

According to a further embodiment, the safety-relevant data indicate a non-motorized traffic participant. The non-motorized traffic participant may be for example a pedestrian or a cyclist crossing the route of the motor vehicle in the direction of travel. Hazardous traffic situations involving non-motorized traffic participants are therefore able to be avoided by suppressing automatic starting.

According to a further embodiment, the safety-relevant data indicate an object detected in the vicinity of the motor vehicle. The dimensions of the vicinity are in this case determined depending on the vehicle speed and the braking distance depending thereon. Hazardous traffic situations involving traffic participants in the vicinity are therefore able to be avoided by suppressing automatic starting.

According to a further embodiment, the safety-relevant data indicate closed vehicle doors. In this case, open vehicle doors are considered to indicate that the driver and/or passengers of the motor vehicle have left said motor vehicle and are on the road. Hazardous traffic situations involving for example passengers who have left the vehicle and are in the route of the motor vehicle are therefore able to be avoided by suppressing automatic starting.

According to a further embodiment, the safety-relevant data indicate an open driver's door. In this case, an open driver's door is considered to indicate that the driver of the motor vehicle has left said motor vehicle and is on the road. Hazardous traffic situations involving for example a driverless motor vehicle are therefore able to be avoided by suppressing automatic starting.

According to a further embodiment, the safety-relevant data indicate a fastened driver's seatbelt buckle. In this case, a fastened driver's seatbelt buckle is considered to indicate that the driver of the motor vehicle is sitting in the driver's seat. Hazardous traffic situations involving for example a driverless motor vehicle are therefore also able to be avoided by suppressing automatic starting.

According to a further embodiment, the safety-relevant data indicate an attentive driver. An attention assistant may for example be used to detect whether the driver is attentive. Hazardous traffic situations in which it is to be expected that an inattentive driver will not intervene in order to avoid a hazardous traffic situation are thereby able to be avoided by suppressing automatic starting.

The disclosure also includes a computer program product, an adaptive cruise control system and a motor vehicle having such an adaptive cruise control system.

The disclosure will now be explained with reference to the drawings.

### BRIEF DESCRIPTION OF THE DRAWINGS

FIGS. 1A to 1D show a schematic illustration of various scenarios that may lead to hazardous traffic situations.

FIG. 2 shows a schematic illustration of a traffic flow for avoiding the hazardous traffic situations shown in FIGS. 1A to 1D.

### DETAILED DESCRIPTION

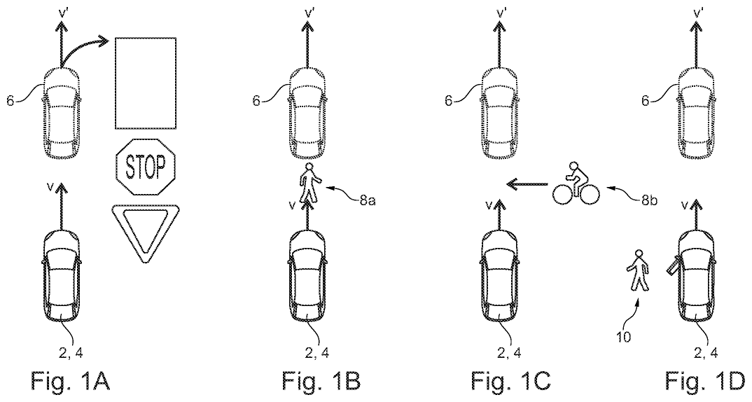

Reference is made firstly to FIGS. 1A to 1D.

These illustrate scenarios in which a motor vehicle 2, in the present exemplary embodiment a car, having an adaptive cruise control system 4 with a stop-and-go function, approaches a vehicle in front 6 that is at a stop v′=0, in the present exemplary embodiment likewise a car, at a speed v.

The stop-and-go function of the adaptive cruise control system 4 in this case independently brings about the effect whereby the speed v of the motor vehicle 2 is reduced to a stop v=0 and the motor vehicle 2 is kept at a predetermined distance from the vehicle in front 6.

The stop-and-go function of the adaptive cruise control system 4 then brings about the effect whereby the motor vehicle 4 automatically restarts after starting of the vehicle in front 6 has been detected.

The stop-and-go function of the adaptive cruise control system 4 however brings about automatic starting only when the vehicle in front 6 has started moving again within a predetermined time period t1. The time period t1 in the present exemplary embodiment has a length of three seconds.

It has however proven in practice that the time period of 3 seconds may be too short, and it may take longer than three seconds until the vehicle in front 6 restarts.

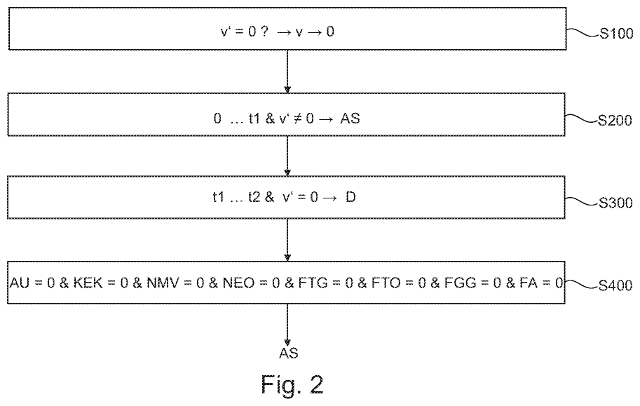

With additional reference to FIG. 2, an explanation is therefore given of a method by way of which, in the case of avoiding hazardous traffic situations, the time period at the end of which the adaptive cruise control system 4 brings about automatic starting is able to be extended to for example 30 seconds.

In this case, the adaptive cruise control system 4 has hardware components and/or software components for the tasks and functions already described and described below.

The method starts with a first step S100. In the first step S100, the adaptive cruise control system 4, upon detecting a stopped (v′=0) vehicle in front 6, drives the drivetrain of the motor vehicle 2 so as likewise to bring said motor vehicle to a stop (v→0).

In a further step S200, the adaptive cruise control system 4 monitors whether the vehicle in front 6 starts moving again (v′≠0) until the end of a predetermined time period t1. In the present exemplary embodiment, the predetermined time period t1 has a length of 3 seconds. When this is the case, the adaptive cruise control system 4 generates a start signal AS for driving the drivetrain of the motor vehicle 2 in order to allow said motor vehicle to start automatically.

If on the other hand the vehicle in front 6 does not restart within the predetermined first time period t1, the method is continued with a further step S300.

In step S300, the adaptive cruise control system 4 changes to a second operating mode. The adaptive cruise control system 4 reads safety-relevant data D that are provided by surroundings sensors and other sensors of the motor vehicle 2.

In a further step S400, the provision of the start signal AS is suppressed if the safety-relevant data D indicate a hazardous traffic situation. Otherwise, if no hazardous traffic situation appears to be present, the start signal AS is provided, if the vehicle in front 6 starts to move again within a predetermined second time period t2. The length of the second time period t2 is 30 seconds in the present exemplary embodiment.

In the scenario shown in FIG. 1A, the motor vehicle 2 is not on a motorway, but rather is behind the vehicle in front 6 that is in a lane to turn right at a crossing. There is thus in this case the risk of crossing traffic that may lead to hazardous traffic situations if the motor vehicle 2 were simply to follow the vehicle in front 6 when said vehicle in front restarts.

The safety-relevant data D may therefore indicate a motorway or approach road AU, since such crossing traffic is not expected here.

The safety-relevant data D may contain a further logic variable that is assigned the value logic zero for a motorway or approach road AU and logic one for other roads.

Turning may mean that it is necessary for example to follow a tight curve. The safety-relevant data D may furthermore indicate an absence of a tight curve KEK or other unclear road portions.

The safety-relevant data D may contain a further logic variable that is assigned the value logic zero for an absence of a tight curve KEK and logic one for a tight curve KEK.

In the scenarios shown in FIGS. 1B and 1C, a non-motorized traffic participant crosses the route of the motor vehicle 2 in the direction of travel. The non-motorized traffic participant may be for example a pedestrian 8a (see FIG. 1B) or a cyclist 8b (see FIG. 1C).

The safety-relevant data D may indicate a non-motorized traffic participant NMV crossing the route of the motor vehicle 2 in the direction of travel.

The safety-relevant data D may contain a logic variable that is assigned the value logic one for non-motorized traffic participants NMW and logic zero for no non-motorized traffic participants NMV in the route of the motor vehicle 2.

The safety-relevant data D may furthermore, in addition or as an alternative, indicate another object NEO detected in the vicinity of the motor vehicle 2.

The safety-relevant data D may contain a further logic variable that is assigned the value logic one for a detected object NEO and logic zero for no detected object NEO.

In the scenario shown in FIG. 1D, a driver 10 has left the motor vehicle 2 after having unfastened his seatbelt by actuating the driver's seatbelt buckle and opened the driver's door.

The safety-relevant data D may indicate closed vehicle doors FTG of the motor vehicle 2.

The safety-relevant data D may contain a further logic variable that is assigned the value logic zero for closed vehicle doors FTG and logic one for open vehicle doors FTG.

In addition or as an alternative, the safety-relevant data D may indicate an open driver's door FTO.

The safety-relevant data D may contain a further logic variable that is assigned the value logic zero for a closed driver's door FTO and logic one for an open driver's door FTO.

The safety-relevant data D may furthermore, in addition or as an alternative, indicate a fastened driver's seatbelt buckle FGG.

The safety-relevant data D may contain a further logic variable that is assigned the value logic zero for a fastened driver's seatbelt buckle FGG and logic one for an unfastened driver's seatbelt buckle FGG.

The safety-relevant data D may furthermore, in addition or as an alternative, indicate an attentive driver FA.

The safety-relevant data D may contain a further logic variable that is assigned the value logic zero for an attentive driver FA and logic one for an inattentive driver FA.

Said individual logic variables of the safety-relevant data D may thus be evaluated in the present exemplary embodiment by way of a simple AND link in order to establish whether the safety-relevant data D indicate a hazardous traffic situation.

The time period within which a start signal AS is provided in response to starting of the vehicle in front 6 is thus able to be extended to for example 30 seconds without impairing safety.

### LIST OF REFERENCE SIGNS

2 Motor vehicle
4 Adaptive cruise control system
6 Vehicle in front
8a Non-motorized traffic participant
8b Non-motorized traffic participant
10 Driver
AS Start signal
AU Motorway or approach road
D Safety-relevant data
FA Driver attentive
FGG Driver's seatbelt buckle fastened
FTG Vehicle doors closed
FTO Driver's door open
KEK Absence of a tight curve
NEO Object detected in the vicinity
NMV Non-motorized traffic participant
t1 First time period
t2 Second time period
v Speed of motor vehicle
v′ Speed of vehicle in front
S100 Step
S200 Step
S300 Step
S400 Step

1-20. (canceled)

21. A method for operating a vehicle having an adaptive cruise control system with a stop-and-go function, comprising:
stopping the vehicle upon detecting that a target vehicle in front of the vehicle has stopped;
providing a start signal within a predetermined first time period upon starting of the target vehicle; and
suppressing the start signal if safety data indicate a hazardous traffic situation after the first time period has elapsed and the target vehicle is stationary.

22. The method of claim 21, wherein the safety data indicate a motorway or approach road.

23. The method of claim 21, wherein the safety data indicate an absence of a tight curve.

24. The method of claim 21, wherein the safety data indicate a non-motorized traffic participant.

25. The method of claim 21, wherein the safety data indicate an object detected in the vicinity of the vehicle.

26. The method of claim 21, wherein the safety data indicate one or more closed vehicle doors.

27. The method of claim 21, wherein the safety data indicate an open driver's door.

28. The method of claim 21, wherein the safety data indicate a fastened driver's seatbelt buckle.

29. The method of claim 21, wherein the safety data indicate an attentive driver.

30. A system, comprising a computer including a processor and a memory, the memory storing instructions executable by the processor to:
stop a vehicle upon detecting that a target vehicle in front of the vehicle has stopped;
provide a start signal to an adaptive cruise control within a predetermined first time period upon starting of the target vehicle; and
suppress the start signal if safety data indicate a hazardous traffic situation after the first time period has elapsed and the target vehicle is stationary.

31. The system of claim 29, wherein the safety data indicate a motorway or approach road.

32. The system of claim 29, wherein the safety data indicate an absence of a tight curve.

33. The system of claim 29, wherein the safety data indicate a non-motorized traffic participant.

34. The system of claim 29, wherein the safety data indicate an object detected in the vicinity of the vehicle.

35. The system of claim 29, wherein the safety data indicate one or more closed vehicle doors.

36. The system of claim 29, wherein the safety data indicate an open driver's door.

37. The system of claim 29, wherein the safety data indicate a fastened driver's seatbelt buckle.

38. The system of claim 29, wherein the safety data indicate an attentive driver.
